(19) United States
(12) Patent Application Publication
(10) Pub. No.: US 2011/0218962 A1
(43) Pub. Date: Sep. 8, 2011

(54) METHOD AND SYSTEM FOR SYNCHRONIZING A SET OF SOFTWARE MODULES OF A COMPUTING SYSTEM DISTRIBUTED AS A CLUSTER OF SERVERS

(75) Inventors: Dominique Vinay, Clamart (FR); Loic Lambert, Le tour du Parc (FR); Philippe Motet, Igny (FR); Soazig David, Plumergat (FR)

(73) Assignee: ACTIVE CIRCLE, Vannes Cedex (FR)

(21) Appl. No.: 13/128,489

(22) PCT Filed: Nov. 10, 2009
(86) PCT No.: PCT/FR2009/052158

§ 371 Date: May 10, 2011

(30) Foreign Application Priority Data
Nov. 10, 2008 (FR) 0806252

(51) Int. Cl. G06F 7/00

(52) U.S. Cl. 707/610; 707/E17.005

(57) ABSTRACT

According to this method of synchronizing a set of software modules of a computing system, each software module is executed on a server of the computing system for the management of a digital data set. The synchronization between two software modules of the set comprises a synchronization (102, 104, 110) of the common data that they manage.

This method comprises a grouping together (106, 112) of software modules of the set, which are activated and synchronized mutually, into at least one synchronized sub-set and an identification of this sub-set, and, for each candidate software module following its booting or rebooting, activated but not synchronized with at least one other software module: search (100) for another activated software module of the set; if another activated software module is found and if it belongs to an identified sub-set, synchronization (102, 104) of the candidate software module with at least one of the software modules of this identified sub-set; integration (106) of the candidate software module into the identified sub-set.

The present invention relates to a method and a system for synchronizing a set of software modules of a computing system distributed as several network interconnected servers. It also relates to a computer programme for the implementation of said method.

The invention applies more specifically to a computing system in which each software module is executed on a server of the computing system for the management of a digital data set, at least part of these digital data being replicated on several software modules, and in which the synchronization between two software modules of the set comprises a synchronization of the common data that they manage.

The digital data are for example description data of a service and the service provided by the computing system is for example a service of storage of data distributed between the network interconnected servers, each server being connected to storage peripherals with hard disk or magnetic tape. In this case, the digital data comprise for example description data of users of the storage service, description data of the infrastructure and the operation of the computing system for the provision of the service, and description data of the data stored and their mode of storage.

The service provided by the computing system may also be a service of transmission of information data, processing of data, calculation, transaction or a combination of these services. In each case, the description data are adapted specifically to the provided service.

The servers of the computing system on which are executed the software modules are generally interconnected by at least one LAN (Local Area Network) and/or WAN (Wide Area Network) type network. This set of network interconnected servers may especially be called “cluster of servers”, the software modules then generally being described as “nodes” of the cluster.

In such an architecture, a particular server or a software module is in principle dedicated to the management of the set of software modules, especially for the synchronization of the replicated digital data. This poses problems when the server or the software module dedicated to the management of the set fails.

For example, in the patent application published under the number FR 2 851 709, it is provided that a service can be provided, via a communication network, to a user by a main server associated with a data base. Auxiliary servers connected to this main server are also provided in the communication network to make this service more rapidly accessible to the user. But they must then be synchronized with the main server, especially with its data base. To perform this synchronization of the main server with the auxiliary servers, the communication network is equipped with specific means of synchronization, for example implemented in servers of resources. It thus appears that certain components of the communication network, the main server and the servers of resources have a very particular role and their failure risks having immediate consequences on the quality of service provided.

In the patent application published under the number US 2007/0233900, a cluster system of calculators provides that several calculators can locally copy a same data stemming from shared storage means. To manage the synchronization of the set of copies of same data, a system of coupling between the calculators provides the updating of the shared storage means each time that data copied locally is modified by a calculator, such that the other calculators can update their locally copied data, with reference to the shared storage means. Here again, the architecture of the system provides a particular role for the coupling system and the shared storage means.

Centralising the synchronization of the software modules, in the sense of a synchronization of the shared digital data that they manage, is however the solution the easiest to envisage. By distributing this synchronization on several or even all of the servers of the computing system, this poses problems of coordination of the servers. No completely satisfactory solution thus exists at the moment.

It may therefore be desired to provide a method of synchronizing software modules of a computing system distributed in several network interconnected servers which makes it possible to overcome at least part of the aforementioned problems and constraints.

An object of the invention is thus a method of synchronizing a set of software modules of a computing system distributed in several network interconnected servers, each software module executing on a server of the computing system for the management of a digital data set, at least part of which is replicated on several software modules, in which the synchronization between two software modules of the set comprises a synchronization of the common data that they manage, characterised in that it comprises the following steps:
grouping together software modules of the set, which are activated and synchronized mutually, into at least one synchronized sub-set and identification of this sub-set, and
for each candidate software module following its booting or rebooting, activated but not synchronized with at least one other software module of the set:
   search for another activated software module of the set,
   if another activated software module is found and if it belongs to an identified sub-set, synchronization of the candidate software module with at least one of the software modules of this identified sub-set, and
   integration of the candidate software module into the identified sub-set.

Thus, while avoiding a centralised synchronization, since each software module activated but not yet synchronized itself manages its synchronization with another software module of the set, the global monitoring of the synchronization of the set of software modules is ensured by the presence and the management of the evolution of uniform sub-sets of synchronized software modules. These sub-sets are identified to enable their monitoring.

In an optional manner, for each candidate software module, if another software module is found but it does not belong to an identified sub-set:
a new synchronized sub-set is created and identified,
the candidate software module is synchronized with the other software module found, and
the candidate software module and this other software module found are integrated into this new identified sub-set.

Also in an optional manner, during the synchronization of the candidate software module with at least one of the software modules of the identified sub-set comprising the other software module found, the choice of at least one software module of this identified sub-set to perform the synchronization is a function of a work load of at least part of the software modules of this identified sub-set.

It is thus possible to distribute advantageously the work load brought about by the synchronization itself.

Also in an optional manner, a method of synchronizing according to the invention may further comprise the following steps:
detection, by a first identified sub-set, of a second identified sub-set,
grouping together of the software modules of these two identified sub-sets into one of these two identified sub-sets,
deletion of the other of these two identified sub-sets, and
synchronization of each software module initially forming part of the deleted sub-set with at least one of the software modules of the sub-set chosen for the grouping together.

Thus, this method of synchronizing tends to favour the merge between uniform sub-sets as long as the complete synchronization of all the software modules of the set is not obtained.

Also in an optional manner, in each identified sub-set, a software module is selected to be specifically marked as identifier of this identified sub-set.

This software module selected in each sub-set then plays a role of marker enabling all of the other software modules to recognise their belonging to an identified sub-set.

Also in an optional manner, a method of synchronizing according to the invention may further comprise the following steps:
detection of a connection break between two complementary parts of an identified sub-set, each comprising at least one software module,
from this identified sub-set, generation and identification of two sub-sets integrating one, respectively the other, of the two complementary parts.

Thus, a break being a source of impossibility to maintain a synchronization of the software modules of a same sub-set, this method provides the separation of each sub-set into two sub-sets as soon as such a connection break is detected.

Also in an optional manner, a method of synchronizing according to the invention may further comprise the following steps:
execution, on a first software module belonging to an identified sub-set, of an action acting on a digital data managed by this first software module,
transmission of a synchronization message identifying the action to the set of other software modules of the same identified sub-set comprising a replication of this digital data,
on reception of this message by any of the software modules concerned, execution of the action identified on this software module so as to act on the replication of the digital data situated on this software module.

Thus, in each constituted and identified sub-set, a particularly efficient and non centralized mechanism of permanent mutual synchronization of the software modules is provided. Indeed, the execution of an action on a first software module of a sub-set has for consequence, thanks to the transmission of a message identifying this action, the execution of this same action on the set of other software modules of the same sub-set managing a replication of the digital data concerned by this action. Consequently, whatever the software module on which the action is firstly executed, the latter fulfils a function of manager of synchronization in the sub-set and the result is the same: everything takes place as if the action was executed on the set of software modules comprising the digital data concerned by the action, in the considered sub-set. No software module thus plays a privileged or particular role from the point of view of the management of the digital data, which makes the complete computing system less vulnerable to breaks in continuity of service in the event of failure of a software module or a server.

Also in an optional manner, a method of synchronizing according to the invention may further comprise the following steps:
during the synchronization of the candidate software module, this comprising part of the digital data, extraction of a state of replications of this part of the digital data on at least one other software module, and recording of the candidate software module as potential receptor of at least one synchronization message identifying an action on a replication of this digital data situated on another software module,
synchronization of the digital data of the software module with the digital data of the other software module and, during this synchronization, placing in a queue any synchronization messages that may have been received,
once the synchronization has ended, processing of the queue.

Another object of the invention is a system of synchronization of a set of software modules of a computing system, comprising several network interconnected servers, each software module executing on a server of the computing system for the management of a data set, at least part of which is replicated on several software modules, in which the synchronization between two software modules of the set comprises a synchronization of the common data that they manage, characterised in that it comprises:
means of identifying at least one sub-set grouping together software modules of the set which are activated and synchronized mutually, and
for each candidate software module following its booting or rebooting, activated but not synchronized with at least one other software module of the set:
   means of searching for another activated software module of the set,
   if another activated software module is found and if it belongs to an identified sub-set, means of synchronizing the candidate software module with at least one of the software modules of this identified sub-set, and
   means of integrating the candidate software module into the identified sub-set.

Finally, another object of the invention is a computer programme downloadable from a communication network and/or saved on a support readable by computer and/or executable by a processor, characterised in that it comprises programme encoding instructions for the execution of the steps of a method of synchronizing as defined previously, when said programme is executed on a computer.

The invention will be better understood on reading the description that follows, given uniquely by way of example and made with reference to the appended drawings, in which:

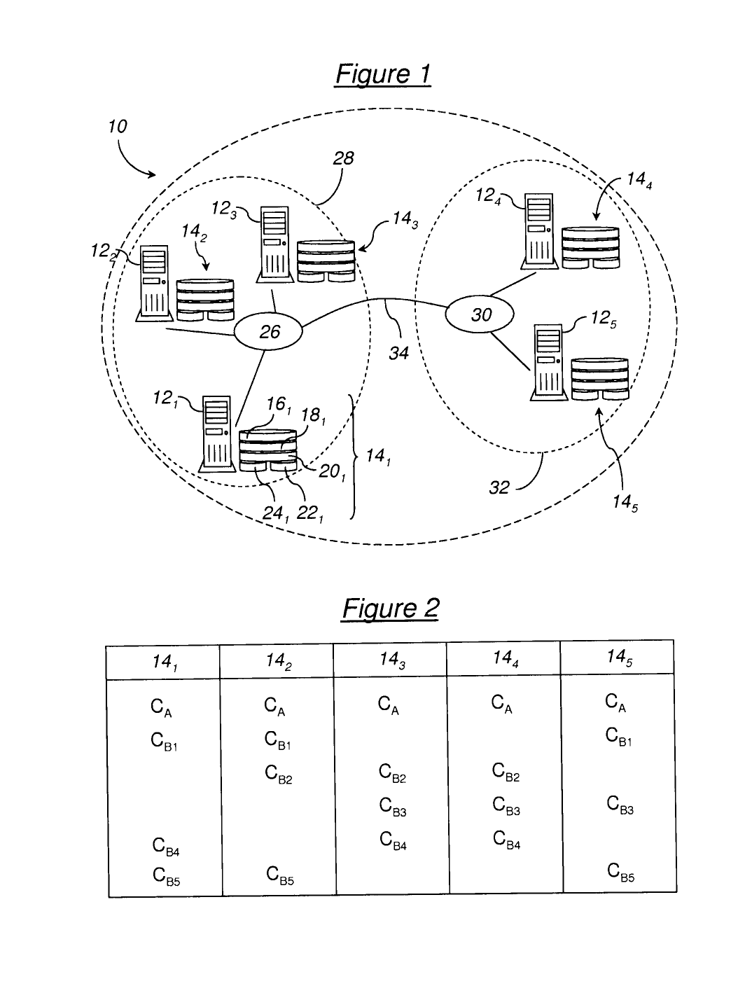

FIG. 1 schematically represents the general structure of a data storage computing system distributed in several network interconnected servers,

FIG. 2 illustrates an example of distribution of description data in the computing system of FIG. 1,

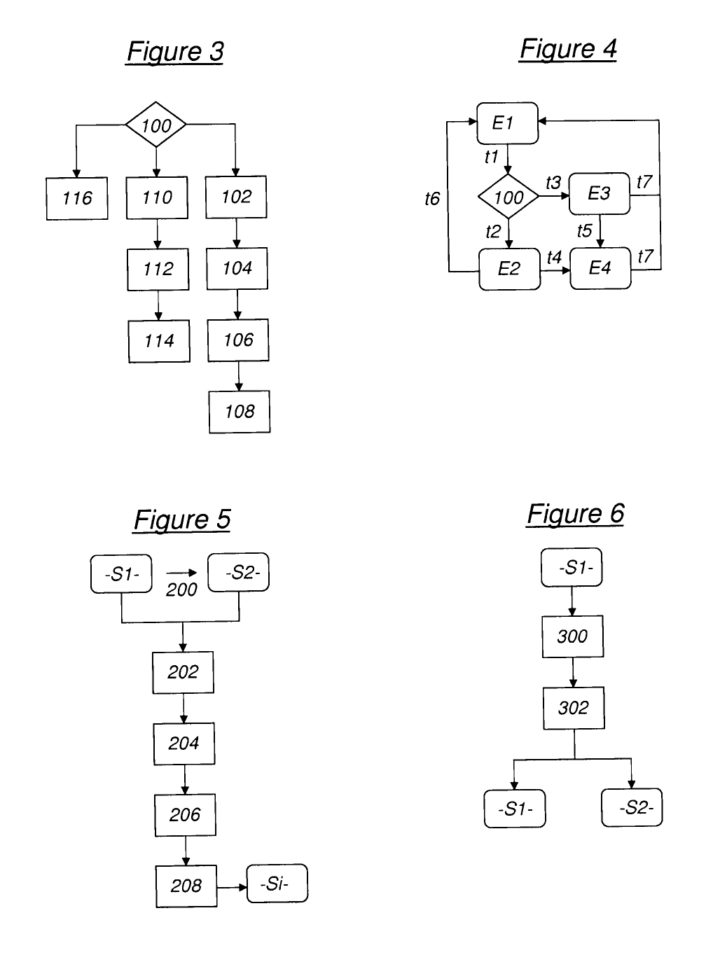

FIG. 3 illustrates the successive steps of a method of synchronizing implemented in the system of FIG. 1 according to an embodiment of the invention,

FIG. 4 represents a diagram of states and transitions between these states of software and hardware modules of the computing system of FIG. 1, for the implementation of the method of synchronizing of FIG. 3,

FIGS. 5 and 6 illustrate partially the successive steps of methods of synchronizing according to other embodiments of the invention,

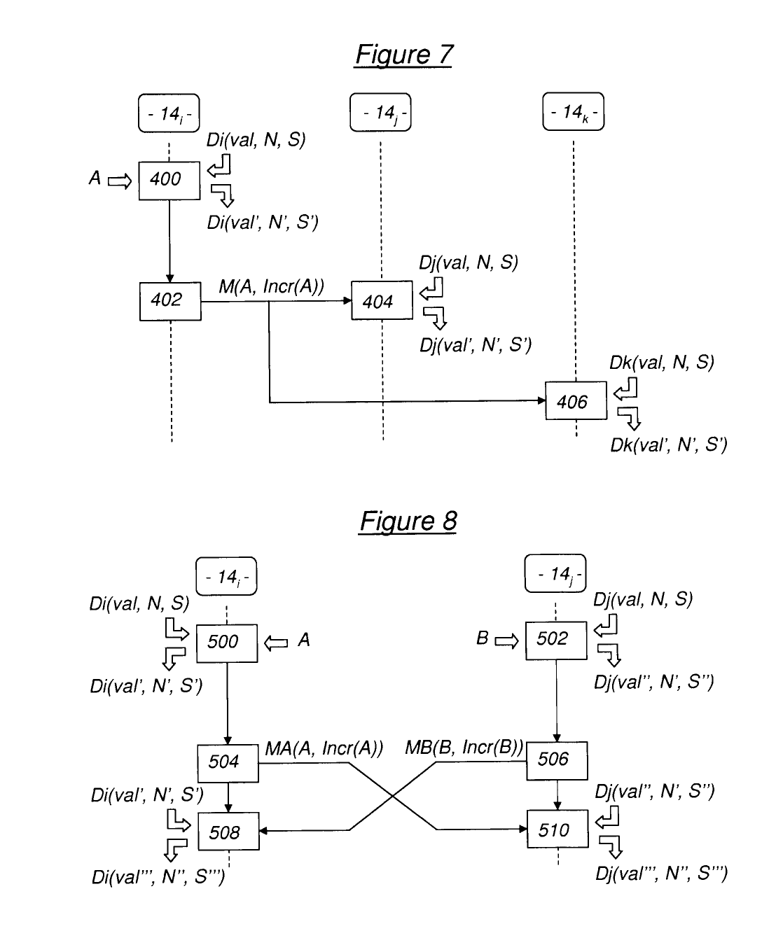

FIGS. 7 and 8 illustrate examples of implementation of a particular step of synchronization of the method of synchronizing of FIG. 3, and

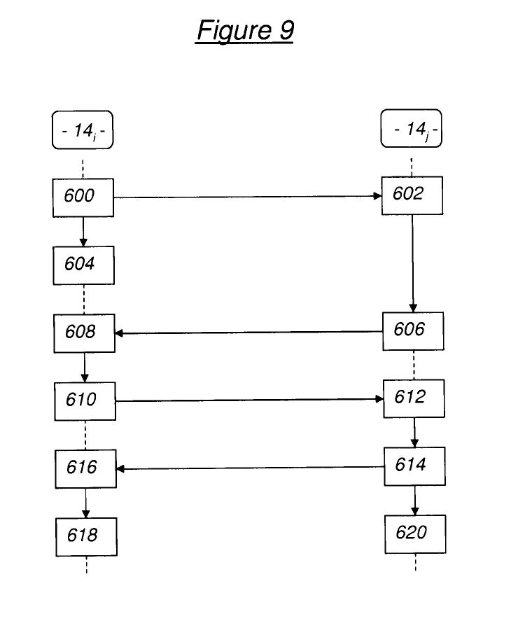

FIG. 9 illustrates an example of implementation of another particular step of synchronization of the method of synchronizing of FIG. 3.

The computing system 10 represented in FIG. 1 comprises several servers 12₁, 12₂, 12₃, 12₄ and 12₅, distributed on several domains. Each server is of conventional type and will not be detailed. On the other hand, on each server 12₁, 12₂, 12₃, 12₄ and 12₅ is installed at least one specific software and hardware module 14₁, 14₂, 14₃, 14₄ and 14₅ for management of a service, for example a data storage service.

Five servers and two domains are represented in FIG. 1 in a purely illustrative manner, but any other structure of computing system distributed in several network interconnected servers may be suitable for the implementation of a method of synchronizing according to the invention. Also for reasons of simplification, a software and hardware module per server is represented, such that the modules and their respective servers could be merged in the remainder of the description, without however having to be merged in a more general implementation of the invention.

The software and hardware module 14₁ of the server 12₁ is detailed in FIG. 1. It comprises a first software layer 16₁ constituted of an operating system of the server 12₁. It comprises a second software layer 18₁ for management of description data of the data storage service provided by the computing system 10. It comprises a third software and hardware layer 20₁ fulfilling at least two functions: a first function of storage, on an internal hard disk of the server 12₁, of description data of the storage service and a second cache memory function, also on this hard disk, of data stored on storage peripherals of the server 12₁. Finally, it comprises a fourth software and hardware layer 22₁, 24₁ of data warehouses, comprising at least one data warehouse on hard disk 22₁ and/or at least one data warehouse on magnetic tapes 24₁. For the remainder of the description, a data warehouse designates a virtual data storage space constituted of one or more partitions of disk, or of one or more magnetic tapes, among the storage peripherals of the server with which it is associated.

The software and hardware modules 14₂, 14₃, 14₄ and 14₅ of the servers 12₂, 12₃, 12₄ and 12₅ will not be detailed because they are similar to the software and hardware module 14₁.

In the example illustrated in FIG. 1, the servers 12₁, 12₂ and 12₃ are mutually interconnected by a first LAN type network 26 to create a first sub-set or domain 28. This first domain 28 corresponds for example to a localised geographic organisation, such as a geographic site, a building or a computer room. The servers 12₄ and 12₅ are mutually interconnected by a second LAN type network 30 to create a second sub-set or domain 32. This second domain 28 also corresponds for example to another localised geographic organisation, such as a geographic site, a building or a computer room. These two domains are mutually connected by a WAN 34 type network, such as the Internet network.

Thus, this computing system in cluster of servers distributed on several geographic sites makes it possible to envisage a storage of data all the more sure given that said data may be replicated on software and hardware modules situated on different geographic sites.

The storage service provided by this computing system 10 and the data actually stored are advantageously completely defined and described by a set of description data that are going to be described in their general principles with reference to FIG. 2. That way, the management of these description data by the software layer 18ᵢ of any of the software and hardware modules 14ᵢ ensures the management of the storage service of the computing system 10.

The description data are for example grouped together into several sets structured according to their nature and if appropriate interconnected. A structured set, which will be called “catalogue” in the remainder of the description, may be in the form of an arborescence of directories themselves containing other directories and/or description data files. The representation of the description data according to an arborescence of directories and files comprises the advantage of being simple and thus economic to design and manage. In addition, this representation is often sufficient for the targeted service. It is also possible, for more complex applications, to represent and manage the description data in relational data bases.

A catalogue of description data may be global, in other words concern description data useful to the whole of the computing system 10, or even local, in other words concern description data specific to one or more software and hardware module(s) 14₁, 14₂, 14₃, 14₄ or 14₅ for management of the service. Advantageously, each catalogue is replicated on several servers or software and hardware modules. When it is global, it is preferably replicated on the whole of software and hardware modules. When it is local, it is replicated on a predetermined number of software and hardware modules, of which at least that or those that it concerns.

By way of example, FIG. 2 represents a possible distribution of catalogues of description data between the five software and hardware modules 14₁, 14₂, 14₃, 14₄ and 14₅.

A first global catalogue C_{A} is replicated on the five software and hardware modules 14₁, 14₂, 14₃, 14₄ and 14₅. It comprises for example data describing the general infrastructure and the general operation of the computing system 10 for the provision of the service, especially the arborescence of domains and software and hardware modules of the computing system 10. It may also comprise data describing potential users of the data storage service and their access rights, for example users enrolled beforehand, as well as the zones of sharing, the structure or the mode of storage and the replication of stored data.

Other catalogues are local, such as for example the catalogue C_{B1}, containing description data specific to the software and hardware module 14₁ such as data relative to the local infrastructure and to the local operation of the server 12₁ and its storage peripherals or to the organisation into warehouses of the software and hardware module 14₁, or instead even the digital data actually stored in these warehouses. This catalogue is replicated as three copies, one of which is on the software and hardware module 14₁. To improve the security and the robustness of the computing system 10, the catalogue C_{B1} may be replicated in several different domains. Here, the complete system comprising two domains 28 and 32, the catalogue C_{B1} is for example saved on the modules 14₁ and 14₂ of the domain 28 and on the module 14₅ of the domain 32.

Likewise, the software and hardware modules 14₂, 14₃, 14₄ and 14₅ are associated with respective local catalogues C_{B2}, C_{B3}, C_{B4} and C_{B5}. For example, the catalogue C_{B2} is saved on the modules 14₂ and 14₃ of the domain 28 and on the module 14₄ of the domain 32; the catalogue C_{B3} is saved on the module 14₃ of the domain 28 and on the modules 14₄ and 14₅ of the domain 32; the catalogue C_{B4} is saved on the module 14₄ of the domain 32 and on the modules 14₁ and 14₃ of the domain 28; and the catalogue C_{B5} is saved on the module 14₅ of the domain 32 and on the modules 14₁ and 14₂ of the domain 28.

The aforementioned list of catalogues of description data is not exhaustive and is only given by way of example, as is the number of replications of each catalogue.

By this replication of catalogues, here on three software and hardware modules for each catalogue, it will be noted that even if a software and hardware module, or even two, is (are) not in operational state, the system as a whole is capable of accessing the set of description data such that the management of the data storage service is not necessarily interrupted. In practice, this continuity of maintained service is efficient from the moment where a synchronization of the catalogues and more generally of the description data is ensured.

The data actually stored are also replicated for questions of security of the storage service provided such that any action or modification concerning these data must also be applied to the different replications. A synchronization of the data actually stored must thus also be ensured.

In other words, a synchronization of the software and hardware modules 14₁, 14₂, 14₃, 14₄ and 14₅, comprising a synchronization of the common data that they manage, must be ensured.

To do this, a method of synchronizing according to the invention will now be detailed with reference to FIGS. 3, 4, 5 and 6.

This method of synchronizing aims to group together the software and hardware modules 14₁, 14₂, 14₃, 14₄ and 14₅ of the computing system 10 into at least one identified sub-set in which all of the software and hardware modules are activated and mutually synchronized. Its purpose may even be to end up only with a single synchronized sub-set, this then grouping together all of the software and hardware modules 14₁, 14₂, 14₃, 14₄ and 14₅ of the computing system 10, synchronized mutually.

This method thus aims principally to manage the booting or the rebooting of a software and hardware module of the computing system 10 with a view to integrating it with one of the existing synchronized sub-sets or with a new sub-set to be created. In an optional manner, it also aims to manage stoppages of software and hardware modules, network breaks, detections of a synchronized sub-set by another, etc.: as many events capable of changing the synchronized sub-sets of the computing system 10.

As illustrated in FIG. 3, during a first step 100, resulting for example from the activation of a software and hardware module 14ᵢ following the booting of a new server in the computing system 10 or the rebooting of an existing server, this software and hardware module, activated but not yet synchronized with another software and hardware module of the computing system 10, searches for another activated software and hardware module of the computing system 10.

If another activated software and hardware module 14ⱼ is found and if it belongs to a synchronized identified sub-set, one passes to a step 102 of selecting at least one of the software and hardware modules of the identified sub-set to carry out a synchronization of the software and hardware module 14ᵢ with this or these selected software and hardware module(s).

First of all, the selection is based on the digital data of the software and hardware module 14ᵢ which must be synchronized. The software and hardware modules of the identified sub-set concerned by this selection are thus those that manage data shared with the software and hardware module 14ᵢ.

In an optional manner, this selection is also a function of a work load of at least part of the software and hardware modules of this identified sub-set. For example, it may be considered that beyond a predetermined load, a software and hardware module of the identified sub-set cannot be selected. Thus, if a software and hardware module in demand temporarily has an overload, it can indicate to the software and hardware module 14ᵢ to choose another software and hardware module. If no software and hardware module in demand is available at a given instant, the software and hardware module 14ᵢ may wait until the activity peak ends to synchronize itself. Thus, the work load is distributed equitably between the software and hardware modules in demand if a large number of software and hardware modules boot at the same time or if a software and hardware module boot whereas the others are very in demand.

Then, during a step 104, a synchronization of the software and hardware module 14ᵢ with the selected module(s) is performed. A non limiting example of such synchronization will be detailed with reference to FIG. 9.

During a following step 106, the software and hardware module 14ᵢ is integrated into the synchronized identified sub-set which thus henceforth comprises an extra component.

Finally, one passes to a step 108 during which one maintains in permanence the software and hardware modules of the identified sub-set synchronized mutually, according to a predetermined mechanism, a non limiting example of which will be detailed with reference to FIGS. 7 and 8. During this step also, the computing system 10 monitors any event capable of making the identified sub-set change: detection of another synchronized sub-set with which to merge, detection of a connection break between two parts of the sub-set then intended to separate, loss of a software and hardware module (for example by stopping the corresponding server), etc.

At step 100, if another activated software and hardware module 14ⱼ is found but it does not belong to a synchronized identified sub-set, one passes to a step 110 of synchronizing the software and hardware module 14ᵢ with the software and hardware module 14ⱼ. This synchronization may be identical to that envisaged in step 104. It will be detailed with reference to FIG. 9.

Then, during a step 112, a new synchronized sub-set is created and identified into which the two software and hardware modules 14ᵢ and 14ⱼ are integrated.

Finally, one passes to a step 114 during which one maintains in permanence the two software and hardware modules 14ᵢ and 14ⱼ of this new identified sub-set synchronized mutually, according to a predetermined mechanism that may be identical to that envisaged at step 108 and which will be detailed with reference to FIGS. 7 and 8. During this step also, the computing system 10 monitors an event capable of changing the new sub-set created: detection of another synchronized sub-set with which to merge, detection of a connection break between the two software and hardware modules 14ᵢ and 14ⱼ then intended to separate, loss of a software and hardware module (for example by stopping of the corresponding server), etc.

At step 100, if no other activated software and hardware module 14ⱼ is found, the software and hardware module 14ᵢ cannot be synchronized and remains isolated, although activated and thus operational. One then passes to a step 116, during which the computing system 10 monitors any event capable of making the synchronization of the software and hardware module 14ᵢ change: detection of a synchronized sub-set into which it could be integrated, detection of another software and hardware module activated but isolated with which it could be synchronized, stopping of the server on which it is implemented, etc.

In an embodiment of the invention, each synchronized sub-set includes a software and hardware module selected to be specifically marked as identifier of this sub-set. For example, in the situation of step 112 described previously, it is the software and hardware module 14ⱼ which may be selected as having to identify the new sub-set created following its detection by the software and hardware module 14ᵢ.

A sub-set is then identified by this selected software and hardware module, such that any event that generates an exclusion of this selected software and hardware module of the sub-set generates the disappearance of this sub-set and the creation if appropriate of one or more new sub-sets.

Any software and hardware module 14ᵢ of the computing system 10 may thus be found in four different states E1, E2, E3 and E4 represented in FIG. 4 with their transitions.

In the first state E1, the software and hardware module 14ᵢ is stopped. In the second state E2, it is activated but isolated, in other words without being synchronized with another software and hardware module of the computing system 10. In the third state E3, it is member of a synchronized identified sub-set. Finally, in the fourth state E4, it is member of a synchronized identified sub-set and marked as identifier of this sub-set.

A first transition t1 shifts the software and hardware module 14ᵢ from its stopped state E1 to step 100 of searching for another activated software and hardware module of the computing system 10. In other words, during step 100, the software and hardware module 14ᵢ is activated but in search of a synchronization of the digital data that it manages. This situation is brought about for example by the booting or the rebooting of the corresponding server.

A second transition t2 shifts the software and hardware module 14ᵢ from step 100 to its activated but isolated state E2. This is the state in which it is found if following step 100 it passes to step 116 because it has detected no other activated software and hardware module.

A third transition t3 shifts the software and hardware module 14ᵢ from step 100 to its state E3 of member of a synchronized identified sub-set. This is the state in which it is found if following step 100 it passes to step 102 (it joins an existing synchronized sub-set) or 110 (it joins a synchronized sub-set created by the isolated software and hardware module that it has detected).

A fourth transition t4 shifts the software and hardware module 14ᵢ from activated but isolated state E2 to its state E4 of identifying a synchronized sub-set. This is the state in which it is found if it has been detected by another software and hardware module to carry out a synchronization. It then becomes the identifier of the new sub-set created.

A fifth transition t5 shifts the software and hardware module 14ᵢ from its state E3 of member of a synchronized identified sub-set to its state E4 of identifier of a synchronized sub-set. This is the state in which it may be found if the sub-set to which it belongs has lost its identifying module (stoppage of the corresponding server for example), or if the software and hardware module 14ᵢ itself has lost contact with the identifying module of the sub-set in which it is found following a connection break. It may then become the identifier of a new created sub-set, but it must for that be selected.

Indeed, in this situation, a new identifying module must be selected for all of the software and hardware modules of the sub-set considered that have lost contact with the initial identifying module: one solution is to create a new sub-set for all of these software and hardware modules and select one thereof to be the identifier of this new sub-set, for example the software and hardware module 14ᵢ.

In other words, in the embodiment described with reference to FIG. 4, if the identifying module of a synchronized sub-set stops, one of the other software and hardware modules of this sub-set becomes the identifying module. But to do this, a new sub-set is created and all of the other software and hardware modules of the former sub-set become members of the new sub-set. If the network connection between two remote sites of a same synchronized sub-set is broken, part of the members of this sub-set is going to find itself separated from the identifying module of this sub-set. Among these software and hardware modules separated from the identifying module, one is going to be selected to become the identifying module of a new sub-set which will include the software and hardware modules of the isolated site. In practice, a new sub-set is created each time that one or more software and hardware modules are separated from the identifying module. One of them becomes by selection (transition t5) the identifying module of the new sub-set.

A sixth transition t6 shifts the software and hardware module 14ᵢ from its activated but isolated state E2 to its stopped state E1.

This transition takes place especially in two situations:
a first situation is the stoppage of the server on which is installed the software and hardware module 14ᵢ;
a second situation is the detection by the software and hardware module 14ᵢ of a synchronized identified sub-set or of another software and hardware module in the state E2.

Indeed, in the second situation, it must synchronize itself with at least one of the software and hardware modules of the detected sub-set to form part thereof (steps 102 to 106) or with the other isolated software and hardware module detected (steps 110, 112). Yet, since the software and hardware module 14ᵢ has evolved in an isolated manner, one solution is to reboot it, which should lead, via step 100, to the transitions t1 and t3 during this rebooting.

A seventh transition t7 shifts the software and hardware module 14ᵢ from its state E3 or E4 of member or identifier of a synchronized identified sub-set to its stopped state E1.

This transition takes place especially in two situations:
a first situation is the stoppage of the server on which is installed the software and hardware module 14ᵢ;
a second situation is the detection by the sub-set in which it finds itself of another synchronized identified sub-set with which it can merge.

In the second situation, if the merge takes place by maintaining the other sub-set and disappearance of the sub-set in which the software and hardware module 14ᵢ is found, the latter and the other software and hardware modules of the sub-set brought about to disappear must synchronize with at least one of the software and hardware modules of the other detected sub-set to form part thereof (steps 102 to 106). Yet, since the two sub-sets have evolved in an isolated manner, one solution is to reboot the software and hardware module 14ᵢ and the other software and hardware modules of the sub-set brought about to disappear, which should lead, via the step 100, to the transitions t1 and t3 during this rebooting.

FIG. 5 illustrates the successive steps implemented in an optional manner by a method of synchronizing according to the invention, when a synchronized sub-set of the computing system 10 detects another thereof, according to the second situation of the transition t7 described previously.

During a first step 200, a first synchronized sub-set S1 detects a second synchronized sub-set S2 with which it is possible to merge.

During a following step 202, a choice is made to know which of the two sub-sets must be deleted and which must be conserved to group together finally all of the software and hardware modules of these two sub-sets. The sub-set conserved will be noted Si, i=1 or 2, and the sub-set deleted will be noted Sj, j=2 or 1.

The choice is made for example by majority logic:
the sub-set comprising the greatest number of software and hardware modules is conserved,
if the two sub-sets comprise the same number of software and hardware modules, chance determines that which is conserved.

The criterion of choice could be different or refined. It could for example take into account a number of modifications executed on the data managed by the software and hardware modules of each sub-set S1 and S2. It could also take into account the number of sessions opened by users on the software and hardware modules of each sub-set S1 and S2, since the rebooting of a software and hardware module necessitates the stoppage of sessions underway on this module and can cause a hindrance for one or more users.

Then, at a step 204, each software and hardware module of the sub-set Sj synchronizes itself with at least one software and hardware module of the sub-set Si. A non limiting example of such a synchronization will be detailed with reference to FIG. 9.

At the following step 206, the sub-set Sj is deleted. Finally, during a final step 208, all of the software and hardware modules initially in this sub-set integrate the sub-set Si.

The steps 204, 206 and 208 apply to all of the software and hardware modules of the sub-set Sj and accompany their successive transitions t7, t1 and t3.

FIG. 6 illustrates the successive steps implemented in an optional manner by a method of synchronizing according to the invention, when a connection break within a synchronized sub-set of the computing system 10 generates two complementary parts of this sub-set, each comprising at least one software module and which can no longer communicate with each other, according to the situation of the transition t5 described previously.

During a first step 300, a synchronized sub-set 51 detects a connection break between two complementary parts of S1 each comprising at least one software module.

One of the two complementary parts of S1 necessarily comprises its identifying module. This part then reassumes the identity of Si.

The other of the two parts comprises software and hardware modules having lost all contact with the identifying module of S1. One then passes to a step 302, during which a new sub-set S2 is created into which are integrated all of the software and hardware modules of this other part. During this integration, no synchronization is necessary. Only one software and hardware module of this new sub-set S2 must be selected to be the identifier thereof. This software and hardware module selected then suits the transition t5.

It has been seen previously that during steps 108 and 114, one maintains in permanence the software and hardware modules of a same sub-set synchronized mutually, according to a predetermined mechanism for which a non limiting example will now be detailed.

To do this, the software layer of each software and hardware module of the computing system 10 comprises:
means of emitting a synchronization message, identifying an action acting on a digital data that it manages, to the set of other software and hardware modules belonging to the same synchronized sub-set and comprising a replication of this digital data, following the execution of this action on said software and hardware module, and
means of executing an action acting on a digital data and identified in a synchronization message, so as to act on the replication of the digital data situated on said software and hardware module, in response to reception of this synchronization message.

Since the digital data, especially the description data, managed by a software and hardware module are advantageously organised into catalogues, a mechanism of permanent synchronization of the catalogues within a same sub-set will now be detailed.

Firstly, it should be pointed out that a synchronization of a catalogue in a sub-set imposes itself from the moment where a replication of a description data of this catalogue is modified on any software and hardware module of this sub-set. A modification of description data may be completely defined by an action A determined on this description data. For example, a modification of a description data concerning a user may be defined by an action on its access rights to the computing system 10 chosen from a set of rights comprising system administrator rights, data administrator rights, operator rights and simple user rights. In this case, the action A identifies precisely the description data to which it applies and the new value of this description data (as it happens: system administrator, data administrator, operator or simple user). The action A is identified by a unique universal identifier and may be saved, such that the current state of a description data may be re-found by knowing the initial state of this description data and the series of actions that have been operated on it since its creation.

Each local replication of a description data D is moreover associated with a version V which comprises a version number N and a signature S. In a preferred embodiment, any modification, creation or deletion made by an action A on a replication of the description data D also modifies its version V in the following manner:
N←N+1;
S←S+Incr(A), where Incr(A) is a random value generated at the execution of the action A on the replication of the description data concerned.

As illustrated in FIG. 7, during a first step 400, an action A is executed on a replication Di of the description data D, this replication Di being stored by the server 12ᵢ. Before the execution of the action A, the replication Di of the description data D has a value val, a version number N and a signature S. After the execution of the action A, the replication Di of the description data D has a value val′, a version number N′=N+1 and a signature S′=S+Incr(A).

For the execution of the action A, the replication Di of the description data D is protected such that other actions on this replication cannot be executed. These other actions, if any, are placed on standby in a list provided for this purpose and are executed sequentially as of the end of execution of the action A.

During a following step 402, a synchronization message M is generated by the software and hardware module 14ᵢ. This message M comprises the universal identifier of the action A, or a complete description of this action A, as well as the value of the signature increment Incr(A). During this same step, the message M is transmitted to software and hardware modules 14ⱼ and 14ₖ belonging to the same sub-set as the software and hardware module 14ᵢ and also comprising a replication of the description data D.

Then, during a step 404, at reception of the synchronization message M, the software and hardware module 14ⱼ executes the action A on the replication Dj of the description data D, so as to update its value, its version number and its signature which then take the respective values val′, N′ and S′. The updating of the version number N is performed by applying the same rule as that applied by the software and hardware module 14ᵢ and the updating of the signature is performed thanks to the transmission of the signature increment Incr(A) generated by the software and hardware module 14ᵢ.

Then also, during a step 406, at reception of the synchronization message M, the software and hardware module 14ₖ executes the action A on the replication Dk of the description data D, so as to update its value, its version number and its signature which then take the respective values val′, N′ and S′.

Thanks to this method of synchronizing, repeated at each execution of an action on any of the description data of the computing system 10, the catalogues replicated on several nodes of a same synchronized sub-set remain identical, during more or less the time of carrying out the synchronization.

Other techniques of modification of the version V of a replication of description data than that presented with reference to FIG. 7 may be envisaged as alternatives, but it is advantageous to provide that the updating of the signature S is incremental and commutative, which makes it possible to manage crossed modifications of different replications of a same description data, as is illustrated by FIG. 8.

Indeed, during a first step 500, an action A is executed on a first instance of a replication Di of the description data D, this replication Di being stored by the server 12ᵢ. Before the execution of the action A, the replication Di of the description data D has a value val, a version number N and a signature S. After the execution of the action A, the replication Di of the description data D has a value val′, a version number N′=N+1 and a signature S′=S+Incr(A).

Even before the software and hardware module 14ᵢ has had the time to send a synchronization message MA to the other software and hardware modules of its sub-set before replication of the description data D, an action B is executed on one of them, the software and hardware module 14ⱼ, during a step 502. During this step, the action B is executed on a second instance of the replication Dj of the description data D. Before the execution of the action B, the replication Dj of the description data D has the value val, the version number N and the signature S. After the execution of the action B, the replication Dj of the description data D has a value val″, different from val′, the version number N′=N+1 and a signature S″=S+Incr(B), different from the signature S′.

Thus, at the end of steps 500 and 502, even though the replications Di and Dj have the same version number N′, their respective signatures and values are different. Their versions V′ and V″, identified both by their version numbers and by their signatures, are thus different.

During a following step 504, the synchronization message MA is generated by the software and hardware module 14ᵢ. This message MA comprises the universal identifier of the action A, or a complete description of this action A, as well as the value of the signature increment Incr(A). During this same step, the message MA is transmitted especially to the software and hardware modules 14ⱼ comprising the replication Dj.

Similarly, during a following step 506, a synchronization message MB is generated by the software and hardware module 14ⱼ. This message MB comprises the universal identifier of the action B, or a complete description of this action B, as well as the value of the signature increment Incr(B). During this same step, the message MB is transmitted especially to the software and hardware module 14ᵢ comprising the replication Di.

During a step 508, at reception of the synchronization message MB, the software and hardware module 14ᵢ executes the action B on the replication Di of the description data D, so as to update its value, its version number and its signature then take the respective values val′″, N″ and S′″. The value val′″ results from the action B on val′, in other words the combination of actions A and B on the value val of the description data D. The value of N″ is equal to N′+1, i.e. N+2. Finally, the value of S′″ is equal to S′+Incr(B)=S+Incr(A)+Incr(B).

Finally, during a step 510, at reception of the synchronization message MA, the software and hardware module 14ⱼ executes the action A on the replication Dj of the description data D, so as to update its value, its version number and its signature which then take the same respective values val′″, N″ and S′″ as for Di at step 508. Indeed, the value val′″ results from the action A on val″, in other words from the combination of actions A and B on the value val of the description data D. The value of N″ is equal to N′+1, i.e. N+2. Finally, the value of S′″ is equal to S″+Incr(A)=S+Incr(B)+Incr(A), thanks to the incremental and commutative property of the updating of the signature.

It will thus be noted that at the end of steps 508 and 510, the replications Di and Dj are correctly synchronized, their identical versions attesting to the identity of their values.

It has been seen previously that during steps 104, 110 and 204, a synchronization of a software and hardware module 14ᵢ is carried out as the need arises with at least one selected software and hardware module 14ⱼ, according to a predetermined mechanism, a non limiting example of which will now be detailed with reference to FIG. 9.

This mechanism makes it possible to make up for any delay or lag taken by the software and hardware module 14ᵢ compared to the software and hardware module 14ⱼ selected in the management of the description data that they have in common.

According to this mechanism, during a first step 600 during which the software and hardware module 14ᵢ is searching for another software and hardware module for the synchronization of at least one of its catalogues of description data, this selects the software and hardware module 14ⱼ. It obviously selects one of the software and hardware modules managing a replication of the catalogue that it wishes to update. When the software and hardware module 14ⱼ is selected, during this same step 600, the software and hardware module 14ᵢ transmits to it its identifier as well as information concerning the versions of each of the description data of its catalogue (i.e. version number and signature).

Then, during a step 602, the software and hardware module 14ⱼ establishes a set representation of the content of its catalogue and creates a waiting list for the reception of any new synchronization messages concerning this catalogue.

Following step 600 also, during a step 604, the software and hardware module 14ᵢ is registered as possessor of a replication of the catalogue and addressee of any synchronization messages concerning said catalogue. It also creates during this step a waiting list for the reception of any new synchronization message concerning said catalogue.

Following step 602, during a step 606, the software and hardware module 14ⱼ compares the versions of the description data of the software and hardware module 14ᵢ with its own.

This search for differences between two replications of a same catalogue may be facilitated when the catalogue of description data is structured according to a tree in which the description data are nodes (when they have a relation of direct or indirect filiation with at least one “son” description data), or leaves (when they are situated at the end of the tree in this hierarchical representation). Indeed, in this case, each node of the tree may be associated with a global signature that represents the sum of the signatures of its “son” data, in other words the description data situated downstream of this node in the tree. Thus, the search for differences takes place by searching through the tree, from its roots towards its leaves, in other words upstream to downstream: each time that a node of the tree has a same global signature in the two replications of the catalogue, this signifies that this node and the set of “son” data of this node are identical, such that it is not useful to explore further the sub-arborescence of the tree defined from this node.

During this same step, the software and hardware module 14ⱼ constitutes a first list of description data comprising the values and versions of the description data of which the version that it possesses is more recent than that of the software and hardware module 14ᵢ. It constitutes moreover if appropriate a second list of description data comprising the identifiers of the description data of which the version that it possesses is less recent than that of the software and hardware module 14ᵢ. It then transmits these two lists to the software and hardware module 14ᵢ.

During a step 608, the software and hardware module 14ᵢ processes the first list so as to update, in its replication of the catalogue, the description data concerned.

During a step 610, it transmits to the software and hardware module 14ⱼ the values and versions of the description data identified in the second list.

Then, during a step 612, the software and hardware module 14ⱼ processes these values and versions of description data identified in the second list so as to update, in its replication of the catalogue, the description data concerned. Each time that it processes an update of description data, it transmits a synchronization message, according to the method described with reference to FIG. 7, to any software and hardware modules of its sub-set comprising a replication of this description data with the exception of the software and hardware module 14ᵢ.

Following this update of catalogue between the software and hardware module 14ⱼ and the software and hardware module 14ᵢ, the set representation of the content of the catalogue is deactivated from the side of the software and hardware module 14ⱼ during a step 614 and the software and hardware module 14ᵢ is informed thereof during a step 616.

Thus, during final respective steps 618 and 620, the software and hardware modules 14ᵢ and 14ⱼ free themselves to process if appropriate the synchronization messages received in their respective waiting lists for the whole duration of 606 to 616, so as to reduce and delete these waiting lists, then to place itself in situation of reproducing the steps of synchronization as described with reference to FIGS. 7 and 8 when the situation occurs.

Steps 600 to 618 are repeated as many times as necessary on the software and hardware module 14ᵢ for the updating of the set of its catalogues of description data.

It is clearly apparent that a method and/or system as described previously enables the decentralised synchronization of replicated data of an computing system distributed in several servers, while ensuring a global monitoring of the synchronization of the set of the software modules by the presence and the management of the evolution of synchronized sub-sets.

It will moreover be noted that the invention is not limited to the embodiment described previously. It will indeed be apparent to those skilled in the art that various modifications may be made to the embodiment described above, in the light of the teaching that has just been disclosed to them. In the claims that follow, the terms used should not be interpreted as limiting the claims to the embodiment explained in the present description, but should be interpreted to include thereof all the equivalents that the claims aim to cover on account of their formulation and the provision of which is within reach of those skilled in the art by applying their general knowledge to the implementation of the teaching that has just been disclosed to them.

1. Method of synchronizing a set of software modules (14₁, 18₁, 14₂, 14₃, 14₄, 14₅) of a computing system (10) distributed in several network interconnected (26, 30, 34) servers (12₁, 12₂, 12₃, 12₄, 12₅), each software module being executed on a server of the computing system for the management of a set (C_{A}, C_{B1}, C_{B2}, C_{B3}, C_{B4}, C_{B5}) of digital data, at least part of which is replicated on several software modules, in which the synchronization between two software modules of the set comprises a synchronization (102, 104, 110) of the common data that they manage, characterised in that it comprises the following steps:
grouping together (106, 112) of software modules of the set, which are activated and synchronized mutually, into at least one synchronized sub-set (S1, S2) and identification of this sub-set, and
for each candidate software module (14ᵢ) following its booting or rebooting, activated but not synchronized with at least one other software module of the set:
search (100) for another activated software module of the set,
if another activated software module is found and if it belongs to an identified sub-set, synchronization (102, 104) of the candidate software module with at least one (14ⱼ) of the software modules of this identified sub-set, and
integration (106) of the candidate software module into the identified sub-set.

2. Method of synchronizing according to claim 1, wherein, for each candidate software module (14ᵢ), if another software module is found but it does not belong to an identified sub-set:
a new synchronized sub-set is created and identified (112),
the candidate software module is synchronized with the other software module found (14ⱼ), and
the candidate software module (14ᵢ) and this other software module found (14ⱼ) are integrated (112) into this new identified sub-set.

3. Method of synchronizing according to claim 1 or 2, wherein, during the synchronization (102, 104) of the candidate software module (14ᵢ) with at least one (14ⱼ) of the software modules of the identified sub-set comprising the other software module found, the choice (102) of at least one software module (14ⱼ) of this identified sub-set to perform the synchronization is a function of a work load of at least part of the software modules of this identified sub-set.

4. Method of synchronizing according to any of claims 1 to 3, further comprising the following steps:
detection (200), by a first identified sub-set (S1), of a second identified sub-set (S2),
grouping together (208) of the software modules of these two identified sub-sets into one (Si) of these two identified sub-sets,
deletion (204) of the other of these two identified sub-sets, and
synchronization (206) of each software module initially forming part of the deleted sub-set with at least one of the software modules of the sub-set (Si) chosen for the grouping together.

5. Method of synchronizing according to any of claims 1 to 4, wherein, in each identified sub-set, a software module is selected to be specifically marked as identifier of this identified sub-set.

6. Method of synchronizing according to any of claims 1 to 5, further comprising the following steps:
detection (300) of a connection break between two complementary parts of an identified sub-set (S1), each comprising at least one software module,
from this identified sub-set (S1), generation (302) and identification of two sub-sets (S1, S2) integrating one, respectively the other, of the two complementary parts.

7. Method of synchronizing according to any of claims 1 to 6, further comprising the following steps:
execution (400), on a first software module (14i) belonging to an identified sub-set, of an action (A) acting on a digital data (Di) managed by this first software module,
transmission (402) of a synchronization message (M) identifying the action (A) to the set of other software modules (14j, 14k) of the same identified sub-set comprising a replication (Dj, Dk) of this digital data,
on reception of this message (M) by any of the software modules concerned, execution (404, 406) of the action identified on this software module so as to act on the replication of the digital data situated on this software module.

8. Method of synchronizing according to any of claims 1 to 7, further comprising the following steps:
during the synchronization of the candidate software module (14i), this comprising part of the digital data, extraction (602) of a state of the replications of this part of the digital data on at least one other software module (14j), and recording (604) of the candidate software module (14i) as potential receiver of at least one synchronization message identifying an action on a replication of its digital data situated on another software module,
synchronization (606, 608, 610, 612) of the digital data of the software module (14i) with the digital data of the other software module (14j) and, during this synchronization, placing in a queue of any synchronization messages that may have been received,
once the synchronization has ended (614, 616), processing of the queue (618, 620).

9. System of synchronizing a set of software modules (14₁, 18₁, 14₂, 14₃, 14₄, 14₅) of a computing system (10), comprising several network interconnected (26, 30, 34) servers (12₁, 12₂, 12₃, 12₄, 12₅), each software module being executed on a server of the computing system for the management of a data set (C_{A}, C_{B1}, C_{B2}, C_{B3}, C_{B4}, C_{B5}), at least part of which is replicated on several software modules, in which the synchronization between two software modules of the set (14ᵢ, 14ⱼ) comprises a synchronization of the common data that they manage, characterised in that it comprises:
means of identifying at least one sub-set grouping together software modules of the set which are activated and synchronized mutually, and
for each candidate software module (14ᵢ) following its booting or rebooting, activated but not synchronized with at least one other software module of the set:
means of searching for another activated software module of the set,
if another activated software module is found and if it belongs to an identified sub-set, means of synchronizing the candidate software module with at least one (14ⱼ) of the software modules of this identified sub-set, and
means of integrating the candidate software module (14ᵢ) into the identified sub-set.

10. Computer programme downloadable from a communication network and/or saved on a support readable by a computer and/or executable by a processor, characterised in that it comprises programme encoding instructions for the execution of the steps of a method of synchronizing according to any of claims 1 to 8 when said programme is executed on a computer.
